(19) United States
(12) Patent Application Publication
(10) Pub. No.: US 2025/0076161 A1
(43) Pub. Date: Mar. 6, 2025

(54) MAGNETIC BASED SAMPLER SYSTEM FOR WATER CONTAMINANTS

(71) Applicant: KING FAHD UNIVERSITY OF PETROLEUM AND MINERALS, Dhahran (SA)

(72) Inventors: Nabeel Saeed Fuad ABUZAID, Dhahran (SA); Muhammad HAWWA, Dhahran (SA); Mazen Khaled NAZAL, Dhahran (SA)

(73) Assignee: KING FAHD UNIVERSITY OF PETROLEUM AND MINERALS, Dhahran (SA)

(21) Appl. No.: 18/457,812

(22) Filed: Aug. 29, 2023

(51) Int. Cl. G01N 1/34

(52) U.S. Cl. CPC G01N 1/34

(57) ABSTRACT

A sampler system includes an enclosure having a top, a bottom and a sidewall that is fluid permeable. The sampler system further includes a sampler apparatus housed within the enclosure. The sampler apparatus includes a sampling component having a support structure and an adsorbent. The sampler apparatus further includes an oscillating component including a spring which connects the sampling component to the bottom of the enclosure. A retaining component includes a first magnet attached to the sampling component and a second magnet separated from the first magnet by a gap.

### CROSS REFERENCE TO RELATED APPLICATION

Aspects of the present disclosure are related to co-pending patent application Ser. No. 18/151,518 filed on Jan. 9, 2023, titled “SAMPLER SYSTEM FOR WATER CONTAMINANTS”, which is incorporated herein by reference in its entirety.

### BACKGROUND

### Technical Field

The present disclosure is directed to water sampling for quality monitoring and contaminant detection, and particularly, to a sampler system for detecting water contaminants and a method of using the sampler system to obtain a sample for water contamination detection.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Generally, water pollution leads to potential risks to fish as well as to fish-consuming wildlife and humans. Therefore, monitoring water contamination to protect both the ecosystem and public health is imperative. As such, the need for measuring the contaminant concentration in water has led to the development of water sampling methodologies for the determination of dissolved contaminant mass in water. A conventional sampler usually includes a sampler enclosure having an adsorbent disposed therein. The sampler is further held in place within a water body at certain location by a support, such as a cable, a buoy, or a rigid arm. Particularly, the sampler is placed at a strategic location in water in order to have the fluid come in contact with the adsorbent, and thereby to adsorb the pollutants. If the water comes in contact with the adsorbent under natural fluid forces, then such process is known as a passive sampling process, and if the water is forced into the adsorbent of the sampler by pumping, then such process is known as an active sampling process. In both sampling processes, samplers are collected after a predetermined time period, and analyzed in the laboratory to measure ion exchange and characterize pollutant nature and concentration. Thus, an environment specialist is able to establish baseline concentrations from the collected pollutants, determine locations of polluting sources, and identify pollutant migration and distribution routes.

Samplers help in minimizing the potential of environmental and public health damage. Further, sampling processes help in short-term, rapid environmental assessments, as well as in long-term monitoring process to prevent catastrophic environmental events. Both active and passive sampling processes are vital in achieving these goals. An active sampling process has advantages, such as faster sampling rate and collection of bigger mass of pollutant, over a passive sampling process. Further, the active sampling process is more efficient than the passive sampling process though the active sampling process is costlier than the passive sampling process. However, the active sampling process involves energy consumption for getting contaminants adsorbed onto the adsorbent of the sampler.

Accordingly, it is one object of the present disclosure to provide a sampling methodology that has the advantages of the active sampling process and has an economic value that is similar to or the same as the passive sampling process.

### SUMMARY

In an exemplary embodiment, a sampler system is described. The sampler system includes an enclosure including a top, a bottom and a sidewall that is fluid permeable. The sampler system further includes a sampler apparatus housed within the enclosure. The sampler apparatus includes a sampling component including a support structure and an adsorbent. The sampler apparatus further includes an oscillating component including a spring connecting the sampling component to the bottom of the enclosure. The sampler apparatus further includes a retaining component including a first magnet attached to the sampling component and a second magnet separated from the first magnet by a gap.

In some embodiments, the first magnet and the second magnet are configured to apply an oscillating force on the sampling component.

In some embodiments, the first magnet and the second magnet have north and south poles, and the first magnet and the second magnet are disposed proximal to one another such that a north pole of one of the first and second magnets faces a south pole of the other one of the first and second magnets.

In some embodiments, the sampler system includes a stopper adjacent to the sampling component and configured to prevent the first magnet from coming into contact with the second magnet.

In some embodiments, the support structure includes a deflecting surface, and the stopper includes a static surface configured to bounce off the sampling component when the deflecting surface comes into contact with the static surface.

In some embodiments, the first magnet and the second magnet have north and south poles, and the first magnet and the second magnet are disposed proximal to one another such that a north pole of one of the first and second magnets faces a north pole of the other one of the first and second magnets.

In some embodiments, the first magnet and the second magnet are configured to apply the oscillating force on the sampling component in response to a water wave or water current.

In some embodiments, the spring is a leaf spring including a cantilever having a first end slidably attached to the bottom of the enclosure and a second end fixedly attached to the sampling component.

In some embodiments, the first magnet is attached to the first end of the cantilever, and the second magnet is attached to the bottom of the enclosure.

In some embodiments, the spring is a leaf spring including a cantilever having a first end fixedly attached to the bottom of the enclosure and a second end fixedly attached to the sampling component.

In some embodiments, the first magnet is attached to the second end of the cantilever, and the second magnet is attached to the sidewall of the enclosure.

In some embodiments, the spring is a coil spring.

In some embodiments, the second magnet is attached to the sidewall of the enclosure.

In some embodiments, the sidewall is shaped as a screen or a mesh, or includes a perforated material.

In some embodiments, the adsorbent of the sampling component is configured to adsorb a water pollutant.

In some embodiments, the support structure is a support substrate or a support frame and receives an absorptive pad including the adsorbent.

In some embodiments, the sampler system includes an attachment point attached to the top of the enclosure.

In some embodiments, the first magnet and the second magnet are permanent magnets.

In some embodiments, the first magnet and the second magnet are permanent bar magnets.

In some embodiments, the enclosure is cylindrical.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic perspective view of a sampler system used for detecting water contaminants, according to certain embodiments;

FIG. 2A is a schematic side view of a sampler apparatus of the sampler system, according to certain embodiments;

FIG. 2B is a schematic diagram illustrating vibration of a sampling component of the sampler apparatus with a pair of magnets, according to certain embodiments;

FIG. 3 is a schematic side view of the sampler system of FIG. 1 implemented in a water body, according to certain embodiments;

FIG. 4A is a schematic side view of a sampler apparatus having a pair of magnets and a stopper, according to certain embodiments;

FIG. 4B is a schematic diagram illustrating vibration of the sampling component between the pair of magnets, according to certain embodiments;

FIG. 5 is a schematic perspective view of a sampler apparatus having the sampling component slidably coupled to an enclosure of the sampler system using a cantilever, according to certain embodiments;

FIG. 6 is a schematic perspective view of a sampler apparatus having the sampling component fixedly attached to the enclosure of the sampler system using the cantilever, according to certain embodiments;

FIG. 7 is a schematic diagram illustrating vibration of the sampling component through a moment generated by a pair of magnets, according to certain embodiments;

FIG. 8 is a perspective view of a porotype of the sampler system of FIG. 1, according to certain embodiments;

FIG. 9A is a schematic side view showing coupling of the adsorptive sampler to the cylindrical enclosure of the sampler system of FIG. 1 using a pair of springs, according to certain embodiments;

FIG. 9B is a schematic perspective view of the adsorptive sampler showing coupling thereof with the cylindrical enclosure using a pair of springs, according to certain embodiments; and

FIG. 10 is a graphical representation comparing sampling efficiency of the conventional sampler and the sampler system of FIG. 1, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to a sampler system which is less expensive than and yet as efficient as a conventional active sampling process. The sampler system utilizes naturally occurring forces in water to vibrate a sampling component of a sampler apparatus disposed within an enclosure of the sampler system, and thereby to enhance or magnify pollutant absorption capacity. The vibrations, oscillations and/or movements of the sampling component increase physical interactions between an adsorbent and the surrounding fluid, which leads to enhanced physical and chemical adsorption. The sampler system can include a spring for connecting the sampling component to a bottom of the enclosure, and a pair of magnets to induce vibration in the sampling component when the sampler apparatus is subjected to excitation forces naturally existing in the water. The excitation forces are associated with gravity waves, tidal waves, and currents due to temperature changes and the Coriolis effect.

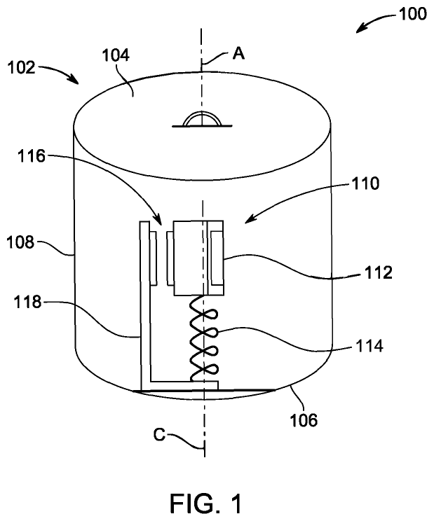

Referring to FIG. 1, a schematic perspective view of a sampler system 100 used for detecting water contaminants is illustrated, according to an embodiment of the present disclosure. The sampler system 100 is also used for monitoring quality of water in a water body by detecting contaminants present in the water. The water body may include, but is not limited to, a sea, a pond, a lake, a river or water stored in a container for various commercial or industrial applications. The sampler system 100 includes an enclosure 102 having a top 104, a bottom 106, and a sidewall 108 extending between the top 104 and the bottom 106 thereof. According to the present disclosure, the enclosure 102 can be cylindrical or any other shape depending on specific design needs. Particularly in this example, a cross-sectional shape of the enclosure 102 is circular. In some embodiments, the cross-sectional shape of the enclosure 102 may be an ellipse, a polygon, or any other shape known in the art. The top 104 of the enclosure 102 is alternatively referred to as ‘the top wall 104’ and the bottom 106 of the enclosure 102 is alternatively referred to as ‘the bottom wall 106’. In one embodiment, each of the top wall 104 and the bottom wall 106 may include a flat surface. In another embodiment, each of the top wall 104 and the bottom wall 106 may include a curved surface. According to the present disclosure, at least the sidewall 108 is fluid-permeable. In an embodiment, the sidewall 108 may be made of a screen, a mesh, or a perforated material to allow flow of water therethrough. Particularly in this example, the sidewall 108 is shaped as a screen or a mesh. In another example, the sidewall 108 includes the perforated material and thus does not have to include macroscopically visible pores or holes. In some embodiments, the perforated material may be separately disposed near or over the screen or the mesh to form the sidewall 108. In some embodiments, the top wall 104 and the bottom wall 106 may be fluid-permeable. The fluid-permeable material allows water and pollutants to pass through.

The sampler system 100 further includes a sampler apparatus 110 housed within the enclosure 102. The sampler apparatus 110 includes a sampling component 112 configured to adsorb one or more contaminants present in the water, an oscillating component 114 configured to connect the sampling component 112 with the bottom wall 106 of the enclosure 102, and a retaining component 116 configured to cause an oscillatory movement of the sampling component 112 within the enclosure 102 based on an initial excitation (e.g. a water wave or water current) and a spring force of the oscillating component 114. The sampler apparatus 110 is further supported on a platform 118 disposed within the enclosure 102.

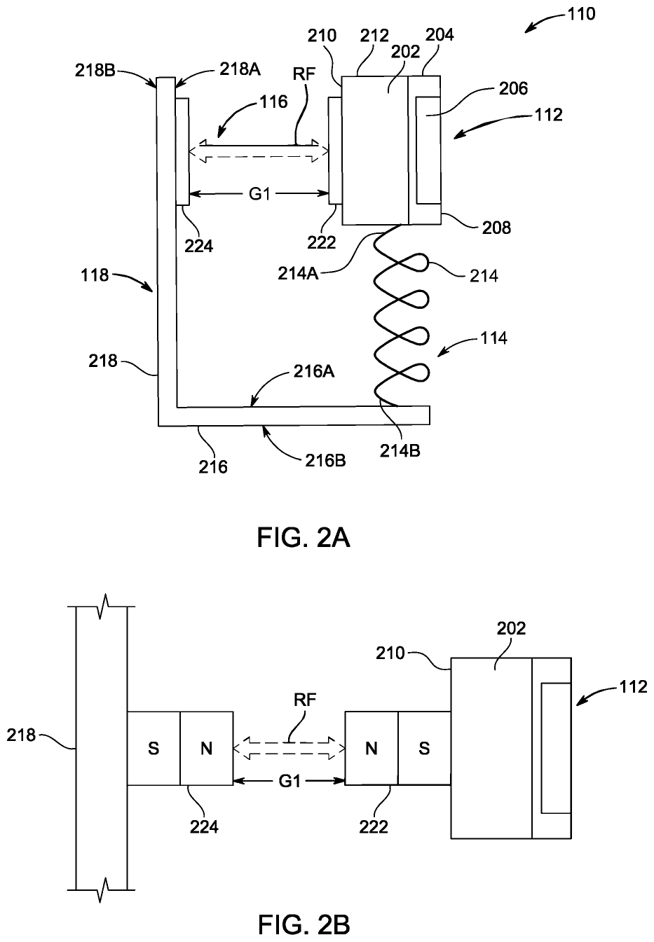

Referring to FIG. 2A, a schematic side view of the sampler apparatus 110 is illustrated, according to certain embodiments. The sampler apparatus 110 includes the sampling component 112 having a support structure 202. The support structure 202 may be otherwise referred to as a housing of the sampling component 112. The sampling component 112 further includes an adsorbent 206 disposed on the support structure 202. The adsorbent 206 of the sampling component 112 is configured to adsorb the water pollutant. The support structure 202 can be in the form of a cylinder, a cuboid or any other suitable shape. Particularly, the support structure 202 includes a front face 208, a back face 210 distal to the front face 208, and a cylindrical surface 212 extending between the front face 208 and the back face 210. In some embodiments, the support structure 202 may have a cross-sectional shape of a square, a rectangle, a triangle, an ellipse, an oval, a circle, or any other polygon shape known in the art. According to the present disclosure, the support structure 202 is a support substrate or a support frame. Particularly, the support structure 202 may act as a substrate or a frame to receive an absorptive pad 204 including the adsorbent 206. In an embodiment, the absorptive pad 204 may be attached to the support structure 202 using an adhesive. Further, the absorptive pad 204 may include a cavity to receive the adsorbent 206 therein. In some embodiments, the adsorbent 206 may be at least one selected from the group consisting of activated carbon, silica gel, zirconia, titania, alumina, zeolite, and ion-exchange resins.

Referring to FIG. 1 and FIG. 2, the support structure 202 is disposed within the enclosure 102 such that the front and back faces 208, 210 of the support structure 202 face the sidewall 108 of the enclosure 102. Further, the support structure 202 is attached to the enclosure 102 using the oscillating component 114. The oscillating component 114 includes a spring 214 having a first end 214A configured to attach to the support structure 202 of the sampling component 112 and a second end 214B configured to attach to the bottom wall 106 of the enclosure 102. According to the present disclosure, the spring 214 is a coil spring. In some embodiments, the spring 214 may be a compression spring. In some embodiments, the spring 214 may be a flexible element made of a metal, an elastomer, or a polymeric material that may be sensible and flexible to move the sampling component 112 based on naturally occurring forces of water, which is otherwise referred to as the water waves or water current, when the sampler system 100 is implemented in the water body.

In an embodiment, the sampler system 100 further includes the platform 118 disposed on the bottom wall 106 thereof. The platform 118 includes a horizontal member 216 configured to be supported on the bottom wall 106 and a vertical member 218 coupled to the horizontal member 216. In an embodiment, the horizontal member 216 of the platform 118 may be cylindrical in shape. Particularly, the horizontal member 216 may include a top surface 216A configured to engage with the second end 214B of the spring 214 and a bottom surface 216B defined in conformance with the bottom wall 106 of the enclosure 102 such that the horizontal member 216 is disposed on the bottom wall 106 intact. In one embodiment, the horizontal member 216 may have a circular shape having a surface area no more than one half of a surface area of the bottom wall 106. In some embodiments, the horizontal member 216 may have an elliptical shape or a polygon shape having a surface area no more than one half of the surface area of the bottom wall 106.

The vertical member 218 includes a first surface 218A facing towards the sampling component 112 and a second surface 218B facing the sidewall 108 of the enclosure 102. The vertical member 218 further includes a bottom end and a top end defining a height greater than or equal to a height of the sampler apparatus 110 defined by the sampling component 112 and the oscillating component 114. The bottom end of the vertical member 218 is configured to couple with the horizontal member 216. In one embodiment, the vertical member 218 may be detachably coupled to the horizontal member 216 using fastening members or any other coupling methods known in the art. In another embodiment, the vertical member 218 may be fixedly attached to the horizontal member 216 using a welding method.

The platform 118 including the horizontal member 216 and the vertical member 218 may be made of a metal or a polymer material. The platform 118 can be disposed on the bottom wall 106 of the enclosure 102 in such a manner that a central axis of the sampler apparatus 110 is concentric with an axis ‘A’ of the enclosure 102. In one embodiment, the platform 118 may be detachably coupled to the bottom wall 106 using a press fit mechanism, fastening members, a quick release mechanism, or any other known mechanisms that will help to detachably connect the platform 118 with the bottom wall 106. In some embodiments, the platform 118 may be permanently attached to the bottom wall 106 using a welding method or a riveting method.

The sampler apparatus 110 further includes the retaining component 116 disposed between the vertical member 218 of the platform 118 and the sampling component 112. The retaining component 116 includes a first magnet 222 attached to the sampling component 112 and a second magnet 224 attached to the vertical member 218. Particularly, the first magnet 222 is attached to the back face 210 of the support structure 202 of the sampling component 112 and the second magnet 224 is attached to the first surface 218A of the vertical member 218. Further, the second magnet 224 is separated from the first magnet by a gap ‘G1’. The gap ‘G1’ may be defined based on various input parameters including, but not limited to, intensity of magnetic field of the first and second magnets 222, 224, size and shape of the sampling component 112, and the spring force of the spring 214 as well as an average strength of water waves or water currents in a water body of interest. The gap ‘G1’ may represent a default state of the first and second magnets 222 and 224 in the absence of an initial excitation (e.g. a water wave or water current), e.g., when not in operation or placed in a water body. Note that in such a default state, there can still be a repulsive force between the first magnet 222 and the second magnet 224. However, the repulsive force can be balanced by other forces exerted on the second magnet 224 which can thus remain stationary in the absence of the initial excitation.

The first magnet 222 and the second magnet 224 are attached to the sampling component 112 and the vertical member 218, respectively, in such a way to apply and/or amplify an oscillating force on the sampling component 112. In some embodiments, the second magnet 224 is attached to the sidewall 108 of the enclosure 102. The second magnet 224 may be attached to the sidewall 108 using fastening members, a press fit mechanism, or any other connecting method known in the art. In some embodiments, the second magnet 224 may be attached to the sidewall 108 using an adhesive. In one embodiment, the first magnet 222 and the second magnet 224 are permanent magnets. The permanent magnets may be defined as magnets that retain the magnetic properties for a longer period of time even in the absence of external magnetic field. In another embodiment, the first magnet 222 and the second magnet 224 are permanent bar magnets. The bar magnet may be defined as a rectangular piece made of iron, steel or ferromagnetic material exhibiting permanent magnetic properties.

Referring to FIG. 2B, a schematic diagram showing movement of the sampling component 112 due to a repulsive force ‘RF’ established between the first magnet 222 and the second magnet 224 is illustrated, according to an embodiment of the present disclosure. The first magnet 222 is attached to the back face 210 of the sampling component 112 and the second magnet 224 is attached to the vertical member 218. In an example, the bar magnet type of the first magnet 222 and the second magnet 224 are shown in FIG. 2B for the illustration purpose of the present disclosure. In one embodiment, a south pole, generally designated by an alphabet ‘S’, of the first magnet 222 is attached to the sampling component 112 and a south pole ‘S’ of the second magnet 224 is attached to the vertical member 218 as such a north pole, generally designated by an alphabet ‘N’, of each of the first magnet 222 and the second magnet 224 face each other. In another embodiment, the north pole ‘N’ of each of the first magnet 222 and the second magnet 224 may be attached to the sampling component 112 and the vertical member 218, respectively, as such the south pole ‘S’ of each of the first magnet 222 and the second magnet 224 face each other. Further, the first magnet 222 and the second magnet 224 are attached to the sampling component 112 and the vertical member 218, respectively, to define the gap ‘G1’ therebetween. As shown in FIG. 2B, the first magnet 222 and the second magnet 224 are arranged in such a way that at least the pair of like poles, such as the north poles ‘N’, of the first magnet 222 and the second magnet 224 face each other. As the pair of like poles of the first magnet 222 and the second magnet 224 face each other, the repulsive force ‘RF’ is established between the first magnet 222 and the second magnet 224. Further, the first magnet 222 and the second magnet 224 are configured to apply and/or amplify the oscillating force on the sampling component 112 in response to the initial excitation (e.g. the water wave or the water current) based on the repulsive force ‘RF’ therebetween. A strength of the oscillating force required to move the sampling component 112 may be further defined by the repulsive force ‘RF’ between the first magnet 222 and the second magnet 224.

According to the present disclosure, when the sampling component 112 slightly moves under a small excitation force due to water waves or water currents, the gap ‘G1’ between the first magnet 222 and the second magnet 224 gets smaller and the repulsive force ‘RF’ is thus increased. The spring force further comes into effect to restore the original geometry of the sampler apparatus 110. Further, the repulsive force ‘RF’ comes into effect. Such cyclic action of the magnetic force and elastic force may induce higher vibration levels and keep the sampler apparatus 110 in an oscillatory motion under the influence of the combined elastic and magnetic forces.

As shown in FIG. 2B, the first magnet 222 (e.g. a roofed permanent magnet), is attached to the back face 210 of the support structure 202 and the second magnet 224 (e.g. another roofed permanent magnet), may be mounted on the sidewall 108 of the enclosure 102. Both the first and second magnets 222, 224 are facing one another. The repulsive force ‘RF’ generated due to north-to-north or south-to-south magnetic force between the first and second magnets 222, 224 can be calculated using

$$F = \frac{{μ}_{0} 6 {M}_{1} {M}_{2}}{4 π {r}^{4}}$$

where μ₀ is the magnetic permeability of water (which is the intervening medium), M₁ and M₂ are the magnetic moments of the first and second magnets 222, 224, respectively, and r is the spacing between the first and second magnets 222, 224.

Vibration characteristics in terms of frequency and amplitude may be selectively chosen by selecting different combinations of elastic springs and permanent magnets.

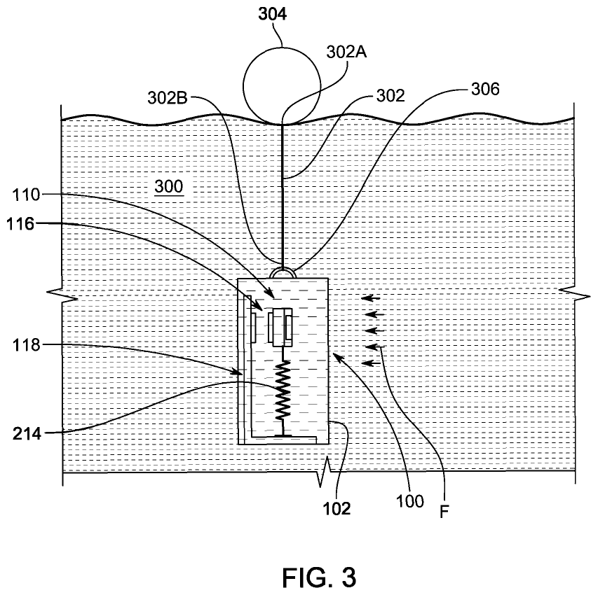

Referring to FIG. 3, a schematic side view of the sampler system 100 implemented in a water body 300 is illustrated, according to certain embodiments. Referring to FIG. 1, FIG. 2A and FIG. 3, the sampler system 100 includes a cable 302 connecting the top wall 104 of the enclosure 102 to a flotation device 304. The flotation device 304 helps to float the sampler system 100 in the water body 300 at a desired height from a water level. The desired height of the sampler system 100 from the water level may be set by a length of the cable 302. A first end 302A of the cable 302 is attached to the flotation device 304 and a second end 302B of the cable 302 is attached to the top wall 104 of the enclosure 102. Particularly, the sampler system 100 includes an attachment point 306 attached to the top wall 104 of the enclosure 102. In an example, the attachment point 306 may be in the form of a hook mounted at a center of the top wall 104 along the axis ‘A’ of the enclosure 102. The attachment point 306 connects the flotation device 304 to the enclosure 102 with the cable 302. In one embodiment, the attachment point 306 may be formed integral with the top wall 104 of the enclosure 102. In another embodiment, the attachment point 306 may be an individual component detachably attached to the top wall 104 of the enclosure 102. In some embodiments, the first end 302A of the cable 302 is attached to the flotation device 304 in such a manner that the desired height of the sampler system 100 from the water level may be adjusted by pulling or loosening the cable 302 with respect to the flotation device 304.

During an implementation of the sampler system 100 in the water body 300, naturally occurring forces ‘F’, otherwise referred to as the excitation force ‘F’, due to the water waves or the water currents acting on the front face 208 of the support structure 202 to move the sampler apparatus 110 in a direction towards the vertical member 218. As the sampling component 112 moves towards the vertical member 218, the repulsive force ‘RF’ is established between the first magnet 222 and the second magnet 224 due to the like poles of each of the first magnet 222 and the second magnet 224. The repulsive force ‘RF’ and a biasing force of the spring 214 cause movement of the sampling component 112 of the sampler apparatus 110 in a direction opposite to the direction of the excitation force ‘F’. Thus, the sampler apparatus 110 experiences a vibrational motion. Vibration frequency can be selectively engineered by selecting a desired combination of a stiffness of the spring 214 and a mass of the sampler apparatus 110. When the sampler apparatus 110 moves back and forth to cause vibration thereof, the adsorbent 206 disposed within the support structure 202 of the sampler apparatus 110 is exposed to increased interaction with the surrounding fluid. Thus, enhanced physical and chemical adsorption is established.

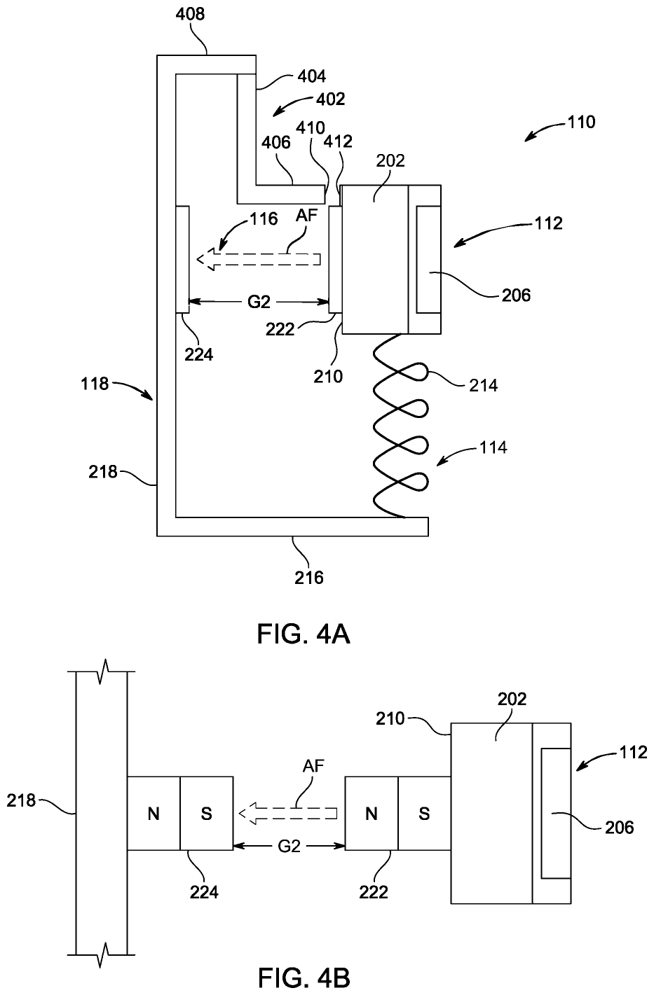

Referring to FIG. 4A, a schematic side view of the sampler apparatus 110 having the first and the second magnets 222, 224 arranged to establish an attractive force ‘AF’ therebetween is illustrated, according to certain embodiments. The sampler apparatus 110 includes the sampling component 112 having the support structure 202 and the adsorbent 206 attached to the platform 118 using the oscillating component 114. Particularly, the support structure 202 is attached to the enclosure 102 using the spring 214 of the oscillating component 114. The sampler apparatus 110 further includes the retaining component 116 disposed between the vertical member 218 of the platform 118 and the sampling component 112. The retaining component 116 includes the first magnet 222 attached to the sampling component 112 and the second magnet 224 attached to the vertical member 218. Particularly, the first magnet 222 is attached to the back face 210 of the support structure 202 of the sampling component 112 and the second magnet 224 is attached to the first surface 218A of the vertical member 218. Further, the second magnet 224 is separated from the first magnet 222 by a gap ‘G2’. The gap ‘G2’ may be defined based on various input parameters including, but not limited to, intensity of magnetic field of the first and the second magnets 222, 224, size and shape of the sampling component 112, and the spring force of the spring 214 as well as an average strength of water waves or water currents in a water body of interest. The gap ‘G2’ may represent a default state of the first and second magnets 222 and 224 in the absence of an initial excitation (e.g., a water wave or water current), e.g., when not in operation or placed in a water body. Note that in such a default state, there can still be an attractive force between the first magnet 222 and the second magnet 224. However, the attractive force can be balanced by other forces exerted on the second magnet 224 which can thus remain stationary in the absence of the initial excitation. The first magnet 222 and the second magnet 224 are attached to the sampling component 112 and the vertical member 218, respectively, in such a way to apply the oscillating force on the sampling component 112.

The sampler system 100 includes a stopper 402 disposed adjacent to the sampling component 112. The stopper 402 may be used to prevent the gap ‘G2’ between the first and second magnets 222, 224 or magnet-ferrous element from becoming too small, which otherwise would lead to sticking of the first and second magnets 222, 224 together. In an embodiment, the stopper 402 is coupled to the vertical member 218 of the platform 118 and is disposed adjacent to the sampling component 112. As shown in FIG. 4A, the stopper 402 includes a vertical arm 404 attached to the vertical member 218 and a horizontal arm 406, extending from the vertical arm 404, and disposed adjacent to the sampling component 112. Particularly, the vertical arm 404 of the stopper 402 is attached to a horizontal extension 408 of the vertical member 218. The stopper 402 is configured to prevent the first magnet 222 from coming into contact with the second magnet 224.

In some embodiments, the stopper 402 includes a static surface 410 defined at an end of the horizontal arm 406. In an example, the static surface 410 may be a curved surface made of a hard material such as a metal. The support structure 202 of the sampling component 112 includes a deflecting surface 412. In an embodiment, the deflecting surface 412 may be disposed on the back face 210 of the support structure 202 such that the deflecting surface 412 of the support structure 202 and the static surface 410 of the stopper 402 may be aligned and positioned at a clearance distance. The static surface 410 of the stopper 402 is configured to bounce off the sampling component 112 when the deflecting surface 412 comes into contact with the static surface 410. In some embodiments, the static surface 410 of the stopper 402 may be made of a rubbery material, and the deflecting surface 412 is a hard surface to bounce off the sampling component 112 when the deflecting surface 412 comes into contact with the static surface 410. In some embodiments, the stopper 402 may include an elongated bar having a first end detachably coupled to the vertical member 218 and a second end disposed adjacent to the back face 210 of the sampling component 112 to prevent the first magnet 222 from coming into contact with the second magnet 224. In some embodiments, the stopper 402 may include an elongated bar having a first end detachably coupled to the horizontal member 216 and a second end disposed adjacent to the back face 210 of the sampling component 112 to prevent the first magnet 222 from coming into contact with the second magnet 224.

Referring to FIG. 4B, a schematic diagram showing movement of the sampling component 112 due to the attractive force ‘AF’ established between the first magnet 222 and the second magnet 224 is illustrated, according to an embodiment of the present disclosure. The first magnet 222 is attached to the back face 210 of the sampling component 112 and the second magnet 224 is attached to the vertical member 218. The bar magnet type of the first magnet 222 and the second magnet 224 are shown in FIG. 4B for the illustration purpose of the present disclosure. In one embodiment, the south pole ‘S’ of the first magnet 222 is attached to the sampling component 112 and the north pole ‘N’ of the second magnet 224 is attached to the vertical member 218 as such the north pole ‘N’ of the first magnet 222 and the south pole ‘S’ of the second magnet 224 face each other. In another embodiment, the north pole ‘N’ of the first magnet 222 and the south pole ‘S’ of the second magnet 224 may be attached to the sampling component 112 and the vertical member 218, respectively, as such the south pole ‘S’ of the first magnet 222 and the north pole ‘N’ of the second magnet 224 face each other. Further, the first magnet 222 and the second magnet 224 are attached to the sampling component 112 and the vertical member 218, respectively, to define the gap ‘G2’ therebetween. As shown in FIG. 4B, the first magnet 222 and the second magnet 224 are arranged in such a way that at least a pair of unlike poles, such as the north pole ‘N’ of the first magnet 222 and the south pole ‘S’ of the second magnet 224 face each other. As the pair of unlike poles of the first magnet 222 and the second magnet 224 face each other, the attractive force ‘AF’ is established between the first magnet 222 and the second magnet 224. Further, the first magnet 222 and the second magnet 224 are configured to apply the oscillating force on the sampling component 112 in response to the water wave or the water current based on the attractive force ‘AF’ therebetween. A strength of the oscillating force required to move the sampling component 112 may be further defined by the attractive force ‘AF’ between the first magnet 222 and the second magnet 224.

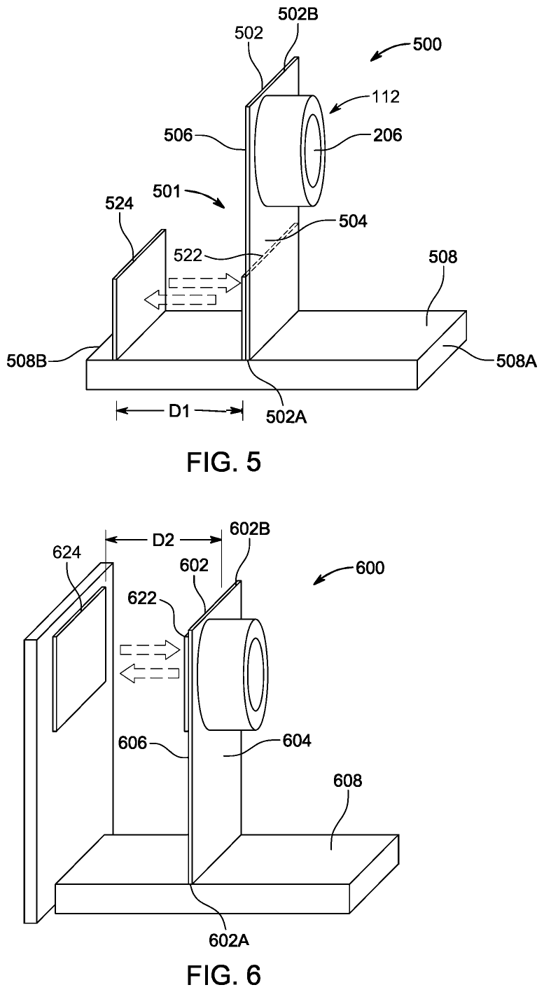

Referring to FIG. 5, a schematic perspective view of a sampler apparatus 500 is illustrated, according to an embodiment of the present disclosure. The sampler apparatus 500 includes a spring 501 configured to attach the sampling component 112 to the bottom wall 106 of the enclosure 102. The spring 501 is a leaf spring including a cantilever 502 configured to couple the sampling component 112 with the bottom wall 106 of the enclosure 102. In one example, the cantilever 502 is in the form of a rigid film and the rigid film is substantially rectangular. The cantilever 502 includes a first end 502A slidably attached to the bottom wall 106 of the enclosure 102 and a second end 502B fixedly attached to the sampling component 112. The cantilever 502 has a height defined between the first end 502A and the second end 502B and a width greater than or equal to a diameter of the sampling component 112. The cantilever 502 is slidably connected to the bottom wall 106 of the enclosure 102 along a flat edge thereof. Particularly, the flat edge of the first end 502A of the cantilever 502 is mounted to a flat impermeable platform 508, which can be substantially rectangular. The cantilever 502 is mounted to the flat impermeable platform 508 equidistant between a first end 508A of the flat impermeable platform 508 and a second end 508B of the flat impermeable platform 508. In an embodiment, a sliding mechanism having a first sliding member and a second sliding member may be attached to the flat impermeable platform 508 disposed on the bottom wall 106 of the enclosure 102. The first sliding member may be attached to a top surface of the flat impermeable platform 508 and the second sliding member may be attached to the first end 502A of the cantilever 502 such that the second sliding member may move relative to the first sliding member to cause oscillatory movement of the cantilever 502. In some embodiments, the first sliding member may be attached to side surfaces of the flat impermeable platform 508.

The sampling component 112 is attached to at least one surface of the cantilever 502 by the back face 210 of the support structure 202 and positioned distal to the bottom wall 106 of the enclosure 102. Particularly, the cantilever 502 includes a first surface 504 configured to engage with the sampling component 112 and a second surface 506 distal to the first surface 504. The first surface 504 of the cantilever 502 is configured to engage with the back face 210 of the sampling component 112. The cantilever 502 has a thickness extending between the first surface 504 and the second surface 506 and has a length defined between the second end 502B and the top surface of the flat impermeable platform 508. The dimensional specifications such as the length and the thickness of the cantilever 502, and the height of the cantilever 502 with respect to the height of the enclosure 102 may be defined based on the water current, otherwise known as the naturally occurring forces ‘F’ exerted by the water on the front face 208 of the sampling component 112. The length, the width, the thickness, and the height of the cantilever 502 may be defined to set a desired stiffness for the cantilever 502 corresponding to a desired vibrational motion of the sampler apparatus 500 to establish enhanced level of pollutant adsorption.

The sampler apparatus 500 further includes a first magnet 522 attached to the first end 502A of the cantilever 502 and a second magnet 524 attached to the bottom wall 106 of the enclosure 102. In an example, the first magnet 522 and the second magnet 524 may be a plate type permanent magnet or permanent bar magnet. The first magnet 522 is attached to the second surface 506 of the cantilever 502 adjacent the top surface of the flat impermeable platform 508. The second magnet 524 is positioned vertically and coupled to the top surface of the flat impermeable platform 508 at a distance ‘D1’ similar to the gap ‘G1’ or ‘G2’. The distance ‘D1’ may be defined based on magnetic strength of the first magnet 522 and the second magnet 524 to cause oscillatory movement of the cantilever 502. In one embodiment, the first magnet 522 and the second magnet 524 may be arranged so that the pair of like poles of the first magnet 522 and the second magnet 524 face each other to establish a repulsive force therebetween. In another embodiment, the first magnet 522 and the second magnet 524 may be arranged so that the pair of unlike poles of the first magnet 522 and the second magnet 524 face each other to establish an attractive force therebetween. Accordingly, the stopper 402 can be used to prevent the first magnet 522 from coming into contact with the second magnet 524 while not shown herein. During an implementation of the sampler apparatus 500, due to the magnetic force between the first magnet 522 and the second magnet 524, and due to the water waves or the water current, the first end 502A of the cantilever 502 may slide over the top surface of the flat impermeable platform 508 to cause vibrational motion of the sampling component 112.

Referring to FIG. 6, a schematic perspective view of a sampler apparatus 600 is illustrated, according to an embodiment of the present disclosure. The sampler apparatus 600 includes a cantilever 602 for coupling the sampling component 112 with the bottom wall 106 of the enclosure 102 as described with reference to the sampler apparatus 500. The cantilever 602 includes a first end 602A fixedly attached to the bottom wall 106 of the enclosure 102 and a second end 602B fixedly attached to the sampling component 112. In one embodiment, the first end 602A of the cantilever 602 may be detachably attached to a top surface of a flat impermeable platform 608 using fastening members. In some embodiments, the first end 602A of the cantilever 602 may be permanently attached to the top surface of the flat impermeable platform 608 using a welding method or a riveting method. The dimensional specifications of the cantilever 602 and mounting of the cantilever 602 with the bottom wall 106 of the enclosure 102 are same as the sampler apparatus 500 described in FIG. 5. The sampler apparatus 600 further includes a first magnet 622 attached to the second end 602B of the cantilever 602 and a second magnet 624 attached to the sidewall 108 of the enclosure 102. In an example, the first magnet 622 and the second magnet 624 may be a plate type permanent magnet or permanent bar magnet. The first magnet 622 is attached to a second surface 606 of the cantilever 602 adjacent the sampling component 112 attached to a first surface 604 of the cantilever 602. The second magnet 624 is positioned vertically and coupled to an inner surface of the sidewall 108 at a distance ‘D2’ similar to the gap ‘G1’ or ‘G2’. The distance ‘D2’ may be defined based on magnetic strength of the first magnet 622 and the second magnet 624 to cause oscillatory movement of the cantilever 602. In one embodiment, the first magnet 622 and the second magnet 624 may be arranged so that the pair of like poles of the first magnet 622 and the second magnet 624 face each other to establish a repulsive force therebetween. In another embodiment, the first magnet 622 and the second magnet 624 may be arranged so that the pair of unlike poles of the first magnet 622 and the second magnet 624 face each other to establish an attractive force therebetween. Accordingly, the stopper 402 can be used to prevent the first magnet 522 from coming into contact with the second magnet 524 while not shown herein. During an implementation of the sampler apparatus 600, due to the magnetic force between the first magnet 622 and the second magnet 624, and due to the water waves or the water current, the second end 602B of the cantilever 602 may deflect to cause vibrational motion of the sampling component 112.

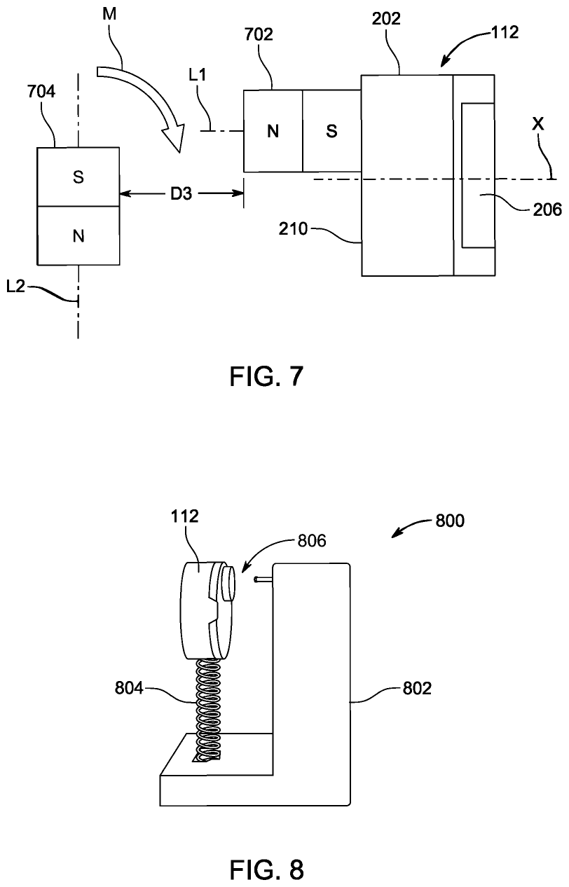

Referring to FIG. 7, a schematic representation of generating a vibration through a moment ‘M’ generated by a first magnet 702 and a second magnet 704 is illustrated, according to an embodiment of the present disclosure. The first magnet 702 is coupled to the back face 210 of the sampling component 112. In one embodiment, the second magnet 704 may be coupled to a vertical member of a platform as described in FIG. 2A. In another embodiment, the second magnet 704 may be attached to the sidewall 108 of the enclosure 102. The first magnet 702 and the second magnet 704 are bar type magnets. The first magnet 702 is attached to the sampling component 112 in such a way that a longitudinal axis ‘L1’ of the of the first magnet 702 is parallel to a central axis ‘X’ of the sampling component 112. Further, a south pole ‘S’ of the first magnet 702 is attached to the back face 210 of the support structure 202. The second magnet 704 is attached to the sidewall 108 or the vertical member of the platform in such a way that a longitude axis ‘L2’ of the second magnet 704 is perpendicular to the longitudinal axis ‘L1’ of the first magnet 702 and a south pole ‘S’ thereof is positioned near a north pole ‘N’ of the first magnet 702. The second magnet 704 is further disposed at a horizontal distance ‘D3’ from the first magnet 702. As the unlike poles of the first magnet 702 and the second magnet 704 face each other, the moment ‘M’ is generated by the first magnet 702 and the second magnet 704. The generated moment ‘M’ further causes vibration of the sampling component 112. Further, combination of force-generating magnets and moment-generating magnets may be put together to bring in loading conditions that lead to flexural-flexural or flexural-torsional types of vibrations.

A prototype of a magnetically induced vibrating sampler 800 is shown in FIG. 8. The sampler 800 includes the sampling component 112 attached to a horizontal member of a platform 802 using a spring 804. A pair of magnets 806 is disposed between the sampling component 112 and a vertical member of the platform 802.

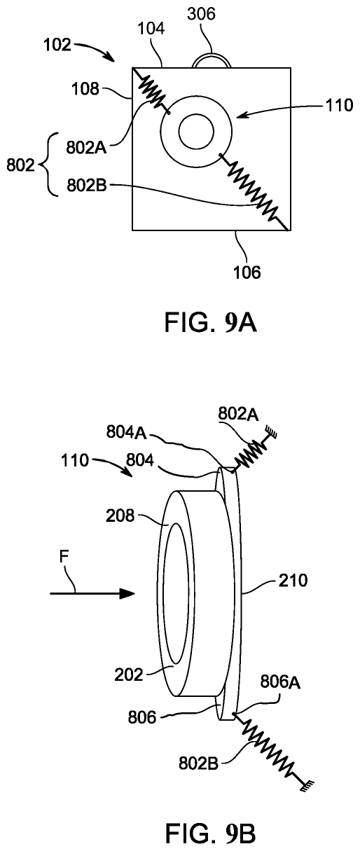

Referring to FIG. 9A, a schematic side view of the sampler system 100 having the adsorptive sampler 110 attached to the cylindrical enclosure 102 using a pair of springs 802 is illustrated, according to an embodiment of the present disclosure. Note that the vertical member 218, the horizontal member 216, the first magnet 222 and the second magnet 224 are omitted herein for simplicity purposes. The pair of springs 802 includes a first spring 802A configured to attach the adsorptive sampler 110 to the top face 104 of the cylindrical enclosure 102 and a second spring 802B configured to attach the adsorptive sampler 110 to the bottom face 106 of the cylindrical enclosure 102. In an embodiment, the first spring 802A and the second spring 802B are compression springs. In some embodiments, the first spring 802A and the second spring 802B may be a flexible element made of a metal, an elastomer, or a polymeric material. In an embodiment, the first spring 802A and the second spring 802B are substantially the same as the spring 214. In some embodiments, the first spring 802A has a first stiffness which is different than a second stiffness of the second spring 802B. In an embodiment, the first stiffness is from 0.4 to 0.9 times greater than the second stiffness, preferably from 0.5 to 0.8 times greater, preferably from 0.6 to 0.7 times greater, or 0.65 times greater. In an embodiment, the second stiffness is from 0.4 to 0.9 times greater than the first stiffness, preferably from 0.5 to 0.8 times greater, preferably from 0.6 to 0.7 times greater, or 0.65 times greater. In some embodiments, the first stiffness of the first spring 802A is same as the second stiffness of the second spring 802B. The first spring 802A and the second spring 802B are attached to the adsorptive sampler 110 diametrically opposite to each other, as shown in FIG. 9A. Further, the first spring 802A and the second spring 802B are mounted opposite to one another between the top and bottom faces 104, 106 of the cylindrical enclosure 102. When the first stiffness of the first spring 802A is different from the second stiffness of the second spring 802B, construction geometry of the adsorptive sampler 110 becomes asymmetric, which biases the vibrational motion of the adsorptive sampler 110. In an embodiment, the first spring 802A and the second spring 802B are mounted on a same side of the cylindrical enclosure 102 between the top face 104 and the bottom face 106. In an embodiment, the first spring 802A and the second spring 802B are both mounted towards the top face 104 of cylindrical enclosure 102 on opposite sides of the adsorptive sampler 110. In an embodiment, the first spring 802A and the second spring 802B are both mounted towards the bottom face 106 of cylindrical enclosure 102 on opposite sides of the adsorptive sampler 110.

FIG. 9B illustrates coupling of the adsorptive sampler 110 with the pair of springs 802 (the first spring 802A and the second spring 802B). Note that the vertical member 218, the horizontal member 216, the first magnet 222 and the second magnet 224 are omitted herein for simplicity purposes. Particularly, the back face 210 of the housing 202 of the adsorptive sampler 110 includes a first flange 804 having a first aperture 804A and a second flange 806 having a second aperture 806A. The second flange 806 is disposed diametrically opposite to the first flange 804. In an embodiment, each of the first flange 804 and the second flange 806 are fabricated or a metal or a plastic. In an embodiment, each of the first flange 804 and the second flange 806 are formed integral with the back face 210 of the adsorptive sampler 110. In an embodiment, each of the first flange 804 and second flange 806 are removable from the back face 210 of the adsorptive sampler 110. Each of the first aperture 804A and the second aperture 806A is configured to couple with one end of each of the first and second springs 802A and 802B, respectively. In an embodiment, each of the first aperture 804A and the second aperture 806A have a diameter that is of from 0.3 to 0.5 times a width of the back face 210, preferably 0.4 times the width of the back face 210.

Referring to FIG. 9A and FIG. 9B, the first spring 802A is attached to a leftmost surface on the top face 104 of the cylindrical enclosure 102 and the second spring 802B is attached to a rightmost surface on the bottom face 106 of the cylindrical enclosure 102, as such the adsorptive sampler 110 is mounted diagonally between the first spring 802A and the second spring 802B. Particularly, another end of each of the first and second springs 802A, 802B is detachably coupled to the top and bottom faces 104, 106 of the cylindrical enclosure 102. In some embodiments, the first spring 802A may be attached to the rightmost surface on the top face 104 of the cylindrical enclosure 102 and the second spring 802B may be attached to the leftmost surface on the bottom face 106 of the cylindrical enclosure 102. In some embodiments, the first spring 802A may be attached to a center surface on the top face 104 of the cylindrical enclosure 102 and the second spring 802B may be attached to a center surface on the bottom face 106 of the cylindrical enclosure 102.

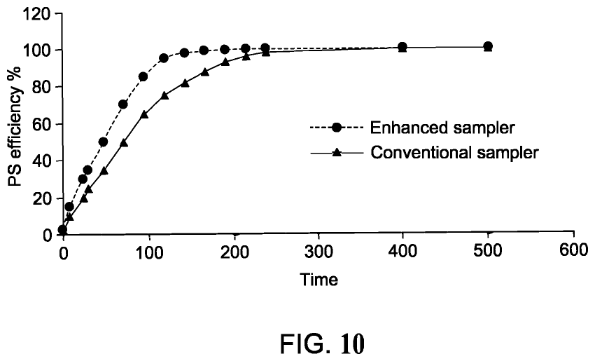

According to the present disclosure, the sampler system 100 includes the sampler apparatus 110 disposed within the enclosure 102 using the spring 214 or the cantilever 502, and the pair of magnets, according to various embodiments. The sampler apparatus 110 utilizes the naturally occurring forces ‘F’ of the water to vibrate the sampling component 112, thereby enhancing the pollutant adsorption capacity. The vibrations of the sampler apparatus 110 further increase the physical interactions between the adsorbent 206 and the surrounding fluid, which further leads to enhanced physical and chemical adsorption. According to the present disclosure, naturally occurring forces are utilized for vibrating the sampler apparatus 110 in order to avoid using energy source to induce mechanical vibration. As such, techniques herein provide a cost-effective vibration methodology with increased pollutant adsorption activity. As shown in FIG. 10, the sampler system 100 of the present disclosure is capable of capturing more contaminants by the mechanism of adsorption compared to conventional sampler systems. Further, the sampling efficiency of the sampler system 100 is higher than that of the conventional sampler systems. Simple construction and a reduced number of components make the sampler system 100 of the present disclosure less expensive and more efficient with the help of spring arrangement and the naturally occurring forces of the water.

According to the present disclosure, the spring 214 and the retaining component 116 including the pair of magnets work together to keep the sampling component 112 vibrating even with a small initial excitation coming from the water wavers or water currents. The sampler system 100 of the present disclosure is effective for the water bodies that are calm with weak currents and small amplitude waves. As the excitation force ‘F’ due to the water waves is too small, the pair of magnets is utilized to excite the sampler apparatus 110 to vibrate.

Numerous modifications and variations of the present disclosure are possible in light of the above teachings. It is therefore to be understood that within the scope of the appended claims, the invention may be practiced otherwise than as specifically described herein.

1. A sampler system, comprising:
an enclosure comprising a top, a bottom and a sidewall that is fluid permeable; and
a sampler apparatus housed within the enclosure, the sampler apparatus comprising:
a sampling component including a support structure and an adsorbent;
an oscillating component including a spring connecting the sampling component to the bottom of the enclosure; and
a retaining component including a first magnet attached to the sampling component and a second magnet separated from the first magnet by a gap.

2. The sampler system of claim 1, wherein the first magnet and the second magnet are configured to apply an oscillating force on the sampling component.

3. The sampler system of claim 2, wherein:
the first magnet and the second magnet have north and south poles, and
the first magnet and the second magnet are disposed proximal to one another such that a north pole of one of the first and second magnets faces a south pole of the other one of the first and second magnets.

4. The sampler system of claim 3, further comprising a stopper adjacent to the sampling component and configured to prevent the first magnet from coming into contact with the second magnet.

5. The sampler system of claim 4, wherein:
the support structure comprises a deflecting surface; and
the stopper comprises a static surface configured to bounce off the sampling component when the deflecting surface comes into contact with the static surface.

6. The sampler system of claim 2, wherein:
the first magnet and the second magnet have north and south poles, and
the first magnet and the second magnet are disposed proximal to one another such that a north pole of one of the first and second magnets faces a north pole of the other one of the first and second magnets.

7. The sampler system of claim 2, wherein the first magnet and the second magnet are configured to apply the oscillating force on the sampling component in response to a water wave or water current.

8. The sampler system of claim 1, wherein the spring is a leaf spring including a cantilever having a first end slidably attached to the bottom of the enclosure and a second end fixedly attached to the sampling component.

9. The sampler system of claim 8, wherein
the first magnet is attached to the first end of the cantilever, and
the second magnet is attached to the bottom of the enclosure.

10. The sampler system of claim 1, wherein the spring is a leaf spring including a cantilever having a first end fixedly attached to the bottom of the enclosure and a second end fixedly attached to the sampling component.

11. The sampler system of claim 10, wherein
the first magnet is attached to the second end of the cantilever; and
the second magnet is attached to the sidewall of the enclosure.

12. The sampler system of claim 1, wherein the spring is a coil spring.

13. The sampler system of claim 1, wherein the second magnet is attached to the sidewall of the enclosure.

14. The sampler system of claim 1, wherein the sidewall is shaped as a screen or a mesh, or includes a perforated material.

15. The sampler system of claim 1, wherein the adsorbent of the sampling component is configured to adsorb a water pollutant.

16. The sampler system of claim 1, wherein the support structure is a support substrate or a support frame and receives an absorptive pad including the adsorbent.

17. The sampler system of claim 1, further comprising an attachment point attached to the top of the enclosure.

18. The sampler system of claim 1, wherein the first magnet and the second magnet are permanent magnets.

19. The sampler system of claim 18, wherein the first magnet and the second magnet are permanent bar magnets.

20. The sampler system of claim 1, wherein the enclosure is cylindrical.
